(19) United States
(12) Patent Application Publication
(10) Pub. No.: US 2025/0175559 A1
(43) Pub. Date: May 29, 2025

(54) IMAGE INSPECTION SYSTEM, INSPECTION DEVICE, INSPECTION METHOD, AND COMPUTER-READABLE RECORDING MEDIUM

(71) Applicant: Konica Minolta, Inc., Tokyo (JP)

(72) Inventor: Shin Igawa, Tokyo (JP)

(73) Assignee: Konica Minolta, Inc., Tokyo (JP)

(21) Appl. No.: 18/952,083

(22) Filed: Nov. 19, 2024

(30) Foreign Application Priority Data
Nov. 24, 2023 (JP) 2023-198929

(51) Int. Cl. H04N 1/00

(52) U.S. Cl. CPC H04N 1/00005; H04N 1/00074; H04N 1/00408; H04N 1/00917; H04N 1/00925

(57) ABSTRACT

An image inspection system includes: an image former; and a hardware processor that acquires a read image obtained by reading an image formed on the recording medium, wherein the hardware processor: inspects the read image, receives an interruption job, and interrupts inspection and image formation of the job being executed when the interruption job is received during execution of the job.

### CROSS REFERENCE TO RELATED APPLICATIONS

The entire disclosure of Japanese patent Application No. 2023-198929, filed on Nov. 24, 2023, is incorporated herein by reference in its entirety.

### BACKGROUND

### Technological Field

The present invention relates to an image inspection system, an inspection device, an inspection method, and a computer-readable recording medium.

### Description of the Related Art

There is known an inspection device that compares a print result in an image forming device with a reference image to inspect the quality of a printed material, for example, the presence or absence of contamination or image missing. For example, Japanese Unexamined Patent Publication No. 2022-83183 discloses a system that is connected to an image forming device and is configured to be able to inspect recording media conveyed from the image forming device. This technique prevents an error from occurring in the inspection result of a printed material when an interruption job occurs during execution of a job related to inspection.

The interruption function is to interrupt another job during execution of a predetermined job. For example, printing based on another job may possibly become urgently required during execution of a predetermined job, such as a case where after printing is performed by the image forming device, reprinting becomes necessary due to some problem occurred during post-processing performed with another post-processing machine. In this case, the interruption job can be executed by interrupting the predetermined job with the interruption function, and when the interruption job is completed, the predetermined job can be restarted from a position next to the interrupted position.

### SUMMARY

However, in the configuration described in Japanese Unexamined Patent Publication No. 2022-83183, an interruption job is not executed until the inspection mode is turned off. That is, in the configuration described in Japanese Unexamined Patent Publication No. 2022-83183, even if an interruption job is generated in the middle of inspection, the interruption job may not be executed quickly, and thus there is a certain limit as a configuration having an interrupt function.

An object of the present invention is to provide an image inspection system, an inspection device, an inspection method, and a computer-readable recording medium capable of promptly executing an interruption job generated in the middle of an inspection.

In order to achieve at least one of the above-described objects, an image inspection system reflecting one aspect of the present invention includes: an image former that forms an image on a recording medium based on a job; and a hardware processor that acquires a read image obtained by reading the image formed on the recording medium. The hardware processor: inspects the read image, receives an interruption job, and interrupts inspection and image formation of the job being executed when the interruption job is received during execution of the job.

In order to achieve at least one of the above-described objects, an inspection device reflecting one aspect of the present invention includes: a hardware processor that acquires a read image obtained by reading an image formed on a recording medium based on a job. The hardware processor: inspects the read image, receives an interruption job, and interrupts inspection and image formation of the job being executed when the interruption job is received during execution of the job.

In order to achieve at least one of the above-described objects, an inspection method for an image in an image inspection system reflecting one aspect of the present invention includes: forming an image on a recording medium based on a job; and acquiring a read image obtained by reading the image formed on the recording medium, inspecting the read image, receiving an interruption job, and interrupting inspection and image formation of the job being executed when the interruption job is received during execution of the job.

In order to achieve at least one of the above-described objects, a computer-readable recording medium reflecting one aspect of the present invention stores an inspection program of an image in an image inspection system, the inspection program causes a computer to execute: a process of forming an image on a recording medium based on a job; and a process of acquiring a read image obtained by reading the image formed on the recording medium, a process of inspecting the read image, a process of receiving an interruption job, and a process of interrupting inspection and image formation of the job being executed when the interruption job is received during execution of the job.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image inspection system according to the present embodiment;

FIG. 2 is a block diagram illustrating a main part of a control system in the image inspection system of the present embodiment;

FIG. 3 is a flowchart showing an operation example of the inspection processing of the image inspection system according to the present embodiment;

FIG. 4 is a flowchart illustrating an operation example of a case where an interruption job occurs in the image inspection system according to the present embodiment;

FIG. 5 is a flowchart illustrating an operation example of first interruption processing;

FIG. 6 is a flowchart illustrating an operation example of a second interruption processing;

FIG. 7 is a flowchart illustrating an operation example of a case where the interruption job occurs in the image inspection system;

FIG. 8 is a diagram illustrating a display example of the display related to the process of notifying the removal of the printed material;

FIG. 9 is a diagram illustrating an example of printing at a job breakpoint point;

FIG. 10 is a flowchart illustrating an operation example of a case where the interruption job occurs in the image inspection system;

FIG. 11 is a flowchart illustrating an operation example of the second interruption processing;

FIG. 12 is a flowchart illustrating an operation example of fourth interruption processing;

FIG. 13 is a diagram illustrating a display example of the display related to the combining confirmation of the printed material;

FIG. 14 is a diagram illustrating a display example of the display related to the prohibition of taking out the printed material;

FIG. 15 is a diagram illustrating a display example of the display related to the combining confirmation of the printed material;

FIG. 16 is a flowchart illustrating an operation example of the second interruption processing;

FIG. 17 is a flowchart illustrating an operation example of the second interruption processing;

FIG. 18 is a flowchart illustrating an operation example of setting control of a page for which a job is interrupted;

FIG. 19 is a diagram illustrating an example of a setting screen of a display of a page on which a job is interrupted; and

FIG. 20 is a diagram illustrating a display example of a job list by and displays.

### DETAILED

### Detailed Description of Embodiments

Hereinafter, one or more embodiments of the present invention will be described with reference to the drawings. However, the scope of the invention is not limited to the disclosed embodiments.

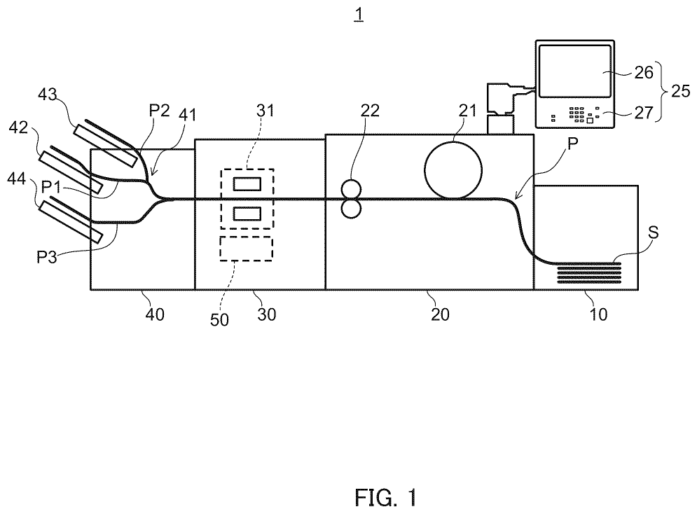

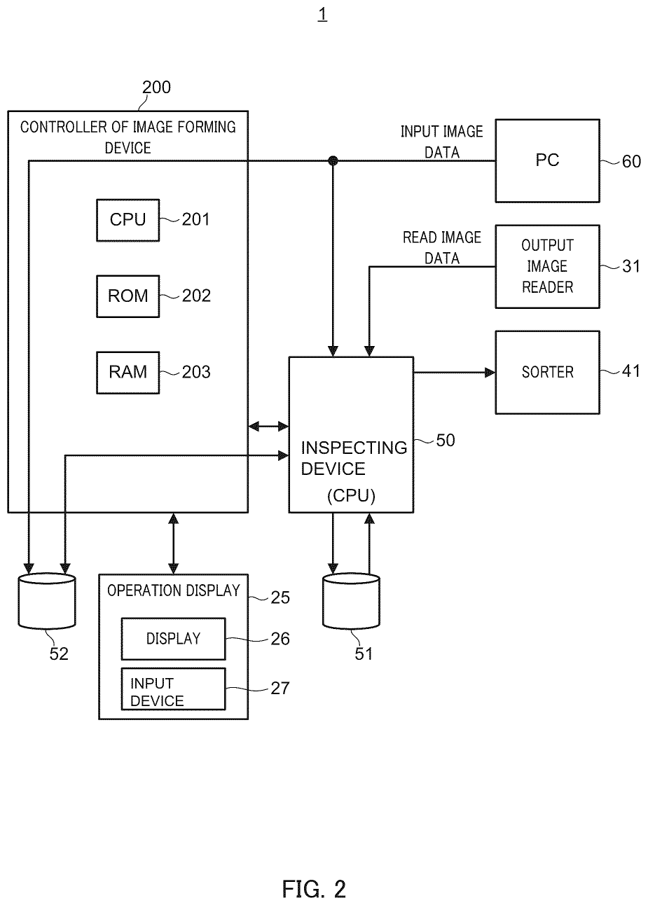

Hereinafter, an embodiment of the present invention will be described in detail with reference to the drawings. FIG. 1 is a diagram schematically illustrating a whole configuration of an image inspection system 1 in an embodiment of the present invention. FIG. 2 is a diagram illustrating a main part of a control system and illustrating a flow of signals and the like between the respective devices constituting the image inspection system 1 in the present embodiment.

The image inspection system 1 illustrated in FIGS. 1 and 2 is a system that forms (outputs) an image on a sheet (recording medium) S by an image forming device 20 and then inspects the quality of the image printed on a sheet S (whether image failure occurs). Specifically, after image formation, the image inspection system 1 reads the image on the sheet S on which the image has been formed, and compares the read image with a reference image to inspect the image printed on the sheet S.

As illustrated in FIG. 1, the image inspection system 1 includes a sheet feeding device 10, the image forming device 20, an image reading device 30, and a post-processing device 40.

The sheet feeding device 10 is a device that feeds the sheet S to the image forming device 20. The image forming device 20 is a device that forms an image based on input image data on the sheet S. The image reading device 30 is a device that reads an image on the sheet S ejected from the image forming device 20. The post-processing device 40 is a device that is disposed on the downstream side of the image reading device 30 (inspecting device) and includes a plurality of sheet ejection trays 42, 43, and 44. The sheet ejection trays 42, 43, and 44 correspond to the “sheet ejector” according to the present invention.

In the image inspection system 1, the sheet feeding device 10, the image forming device 20, the image reading device 30, and the post-processing device 40 are physically connected in this order from the upstream side in the conveyance direction of the sheet S so that device main bodies thereof are coupled to each other. Thus, a conveyance path P for the sheet S is formed continuously between these plurality of devices. The conveyance path P is branched by a sorter 41 of the post-processing device 40 into a path P1 continuous with the sheet ejection tray 42, a path P2 continuous with the sheet ejection tray 43 above the sheet ejection tray 42, and a path P3 continuous with the sheet ejection tray 44 below the sheet ejection tray 42.

For the sake of simplicity, the conveyance path P in the image forming device 20 is indicated by a single line in FIG. 1, but a duplex conveyance path for duplex printing is provided in the actual image forming device 20. Furthermore, for simplicity, in FIG. 1, the number of paths branched in the post-processing device 40 is three, that is, P1, P2, and P3, but more branched paths can be provided according to the number of sheet ejection trays or the like.

The sheet feeding device 10 can accommodate sheets S of various sizes and paper types. The sheet feeding device 10 includes a sheet feed roller for feeding the stored (loaded) sheets S one by one, and a motor for driving the sheet feed roller.

The image forming device 20 includes an intermediate transfer type image former 21 utilizing an electrophotographic process technology. For example, the image former 21 includes a photosensitive drum and an intermediate transfer belt (not illustrated). In the image former 21, toner images of respective colors of Y (yellow), M (magenta), C (cyan), and K (black) formed on the photosensitive drum are primarily transferred to the intermediate transfer belt. In addition, after the toner images of four colors are superimposed on the intermediate transfer belt, the toner images are secondarily transferred to the sheet S to form a toner image. A fixer 22 is disposed on the downstream side of the image former 21 in the conveyance direction of the sheet S.

The fixer 22 applies heat and pressure to the conveyed sheet S on which the toner images have been secondarily transferred, thereby fixing the toner images on the sheet S. Since the image former 21 and the fixer 22 have known configurations, detailed description thereof is omitted. Furthermore, the method of image formation in the image forming device 20 is not limited to the above-described method, and other various methods are applicable.

The device main body of the image forming device 20 includes an operation display 25. The operation display 25 is, for example, a liquid crystal display (LCD:) with a touch panel Liquid Crystal Display It functions as a display 26 and an input device 27.

According to a display control signal input from a controller 200 described later, the display 26 displays various operation screens, states of images, individual function operation status, or the like.

The input device 27 includes various operation keys (so-called hardware switches) such as a numeric keypad and a start key. The input device 27 receives various input operation from a user, and outputs an operation signal to the controller 200.

Further, the display 26 displays various icons (so-called software switches) which can be selected by a cursor (pointer) or the like on various screens which will be described later. The display 26 receives various input operation from a user, and outputs an operation signal to the controller 200.

As illustrated in FIG. 2, the image forming device 20 includes the controller 200 that governs the control of the entire image forming device 20. The controller 200 includes a CPU (Central Processing Unit) 201, a ROM (Read Only Memory) 202, a RAM (Random Access Memory) 203, and the like. The controller 200 controls operation of units/sections included in the image forming device 20 in addition to the image former 21, the fixer 22, and the operation display 25 described above. That is, the CPU 201 of the controller 200 reads a program corresponding to processing content from the ROM 202 and develops the program in the RAM 203. Next, the controller 200 cooperates with the deployed program to centrally control operations of the image former 21, the fixer 22, the operation display 25, and other blocks in the image forming device 20.

Examples of other blocks included in the image forming device 20 include an image processor, a sheet conveyer, and a communicator (or communication interface). The image processor performs various kinds of correction, such as tone correction, on the input image data. The sheet conveyer drives a plurality of conveyance rollers that convey the sheet S. The communicator communicates with an external device such as a server via a communication network or the like. Furthermore, the image forming device 20 may be configured as a copier that copies a document image onto the sheet S. That is, the image forming device 20 may be configured to include an automatic document feeder (ADF), a document image scanning device (scanner), and the like. Since these blocks described above are known components, illustration and description thereof are omitted.

As illustrated in FIGS. 1 and 2, the image reading device 30 includes an output image reader 31 that optically reads the image (toner image) on the sheet S ejected from the image forming device 20. Specifically, the output image reader 31 optically scans the sheet S, forms an image of reflected light from the sheet S on a light receiving surface of a charge coupled device (CCD) sensor (not illustrated), and reads images on both sides of the sheet S. The output image reader 31 generates read image data on the basis of the reading result. The read image data generated by the output image reader 31 is input to an inspecting device 50 to be described later.

As illustrated in FIGS. 1 and 2, the post-processing device 40 includes a sorter 41. The sorter 41 changes over the conveyance rollers for conveying the sheet S whose image has been read by the image reading device 30, the sheet ejection trays 42, 43, and 44 for ejecting the sheet S, and the ejection destination (or conveyance route) of the sheet S. Although a configuration including three sheet ejection trays 42, 43, and 44 is illustrated in FIG. 2 for simplicity, the number of sheet ejection trays is arbitrary and more sheet ejection trays may be provided. The sorter 41 includes a switching gate that switches the ejection destination (conveyance route) of the sheet S to any of the route P1, the route P2, and the route P3. Furthermore, the sorter 41 includes a drive source such as a solenoid for driving the switching gate, an interface for transmitting and receiving data to and from the image forming device 20 and the inspecting device 50, and the like.

In addition, the post-processing device 40 can have various additional functions depending on the use, such as a cutter to cut the sheet S, a stapler to staple the sheet S, a sheet folding mechanism to fold the sheet S, and an affixing mechanism to affix a tape to the sheet S. Since these additional functions are known components, illustration and description thereof are omitted.

As illustrated in FIG. 2, the image inspection system 1 includes the inspecting device 50 that inspects the quality (presence or absence of image failure) of the output image formed (output) on the sheet S on the basis of the read image data generated by the image reading device 30. The inspecting device 50 includes a hardware processor or computer such as a CPU, a ROM, and a data storage 51 to be described later. The inspecting device 50 executes a job (hereinafter, referred to as an “inspection job”) of inspecting the quality of an output image (presence or absence of image failure) by the CPU reading and executing a program stored in the ROM.

In the present embodiment, the inspecting device 50 has a function of generating and registering a reference image (also referred to as a correct image) which is a comparison target when an image inspection is performed based on a read image generated by the image reading device 30.

Further, the inspecting device 50 has a function of inspecting the presence or absence of an image defect by comparing the read image generated by the image reading device 30 with the reference image.

The inspecting device 50 may be, for example, physically incorporated in a housing of the image reading device 30, the post-processing device 40, the image forming device 20, or the like, or may be configured as a device physically independent of these devices. In the example illustrated in FIG. 2, the inspecting device 50 is a device incorporated in the image reading device 30, and is electrically connected to the controller 200 or the like of the image forming device 20.

As illustrated in FIG. 2, the image inspection system 1 further includes a PC 60. The PC 60 outputs input image data and data (hereinafter, referred to as reference data) of printing conditions (various user setting values such as the number of pages of a printed material, a printing method (for example, double-sided printing/single-sided printing), and the number of print copies).

In the example illustrated in FIG. 2, the PC 60 is adapted to supply such reference data to both the image forming device 20 (controller 200) and the inspecting device 50. As another example, a relay device may be provided which divides the reference data transmitted from the PC 60 into two and transmits the divided data to the controller 200 and the inspecting device 50.

Furthermore, as illustrated in FIG. 2, the image inspection system 1 includes data storages 51 and 52 for storing various data such as the above-described reference data.

The data storage 51 is a part of the inspecting device 50 and is used to temporarily store the reference data. The data storage 51 stores various data relating to the image defect analyzed by the inspecting device 50.

Further, the data storage 51 stores and accumulates various setting contents related to the image inspection as data of the inspection profile. Here, the inspection profile includes information indicating the contents of a print job in which an image to be inspected is printed and printing conditions. The information indicating the printing conditions includes, for example, the size of the sheet S to be used for printing, the number of sheets to be printed and the number of copies, and whether to perform double-sided printing.

On the other hand, the data storage 52 is provided in the main body (housing) of the image forming device 20, and is connected to the controller 200 and the CPU of the inspecting device 50 via an interface (not shown). The data storages 51 and 52 can use various data storage media such as an HDD and a semiconductor memory.

In one specific example, first, the image forming device 20 stores the setting information of the print job including the information indicating the above-described printing conditions in the data storage 52. Thereafter, when creating the inspection profile, the inspecting device 50 reads the information indicating the printing conditions from the data storage 52 and stores the information in the data storage 51 as a part of the inspection profile.

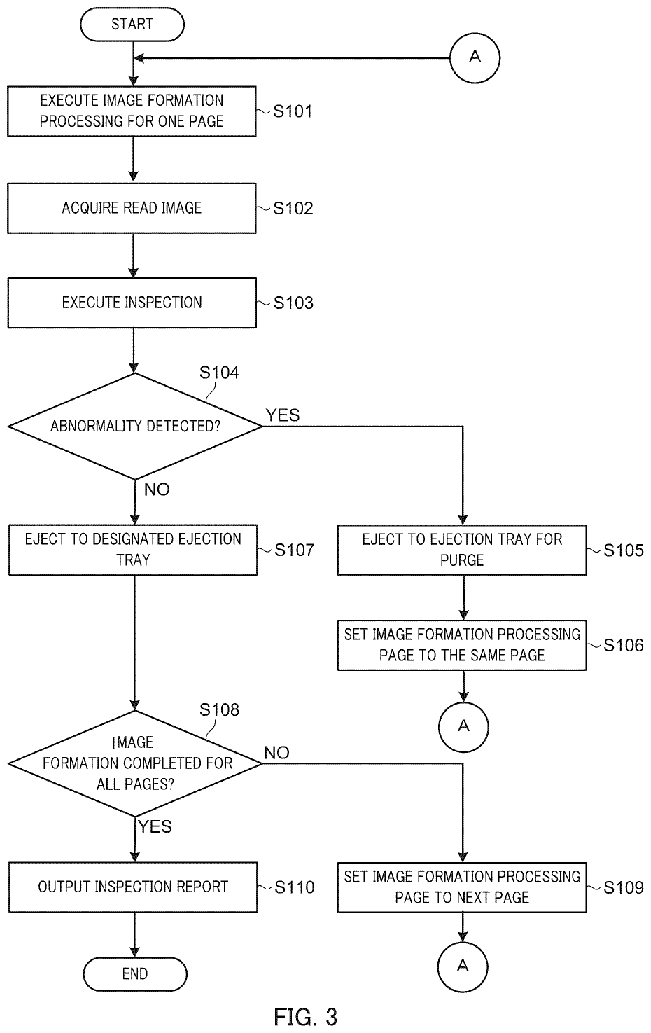

Next, a flow of an inspection process of the image inspection system 1 according to the present embodiment will be described. FIG. 3 is a flowchart illustrating an operation example of an inspection process of the image inspection system 1 according to the present embodiment. The process of FIG. 3 is executed, for example, when the controller 200 receives an instruction to execute a predetermined job. The predetermined job is a job including the above-described print job and inspection job, for executing inspection processing after execution of image forming processing based on image data.

As illustrated in FIG. 3, the controller 200 executes image formation processing for one page (step S101). After step S101, the controller 200 acquires the read image read by the image reading device 30 from the sheet S on which the image is formed in step S101 (step S102).

After step S102, the controller 200 executes inspection processing by the inspecting device 50 (step S103). In the inspection processing, the read image is compared with a reference image corresponding to the read image. In the inspection processing, when the difference between the read image and the reference image is large, namely, (equal to or) larger than a predetermined value, the controller 200 detects that the image on the sheet S is abnormal. Furthermore, in the inspection processing, when the difference between the read image and the reference image is small, namely, (equal to or) smaller than the predetermined value, the controller 200 detects that the image on the sheet S is normal.

After step S103, the controller 200 determines whether or not an abnormality of the image is detected (step S104). As a result of the determination, when an abnormality is detected (step S104, YES), the controller 200 ejects the sheet S to a sheet ejection tray for purging (step S105). Next, the controller 200 sets the page for the image formation processing to the same page (step S106), and the process returns to step S101. The sheet ejection tray for purging is a tray to which the sheet in which the abnormality of the image is detected is ejected.

On the other hand, when an abnormality is not detected (step S104, NO), the controller 200 ejects the sheet S to a specified sheet ejection tray (step S107). The specified sheet ejection tray is a tray to which a sheet having a normal image is ejected, and is a tray different from the sheet ejection tray for purge. In FIG. 1, for example, the sheet ejection tray denoted by reference sign 42 may be the specified sheet ejection tray, and the sheet ejection tray denoted by reference sign 43 may be the sheet ejection tray for purging.

Next, the controller 200 determines whether or not the image formation of all the pages in the predetermined job is completed (step S108). As a result of the determination, when the image formation for all the pages has not been completed (step S108, NO), the controller 200 sets the page for the image formation processing to the next page in the predetermined job (step S109), and the process returns to step S101.

On the other hand, when the image formation of all the pages is completed (step S108, YES), the controller 200 creates and outputs an inspection report (step S110). After step S110, the present control ends. The inspection report is a report which proves that the printed materials of the job have been inspected correctly.

Furthermore, in the present embodiment, it is possible to execute a job (interruption job) in which another job is interrupted during execution of the predetermined job described above. When the interruption job is executed, the predetermined job is interrupted. Then, when the interruption job is completed, the predetermined job is restarted from the next place of the interruption place. As a result, when the other job needs to be urgently executed during the execution of the predetermined job, the other job can be interrupted.

More specifically, when the user instructs execution of the interruption job via the input device 27 during execution of the predetermined job, the controller 200 receives the interruption job. When receiving the interruption job during execution of the predetermined job, the controller 200 interrupts inspection and image formation of the job being executed.

When receiving the interruption job during execution of the predetermined job, the controller 200 inserts a page related to image formation of the interruption job between pages before and after interruption of image formation of the predetermined job. Then, the controller 200 performs a control so as to continuously execute the interruption job from the interruption place of the predetermined job. After processing of all pages of the interruption job is completed, the controller 200 restarts the predetermined job.

In addition, in a case where the read image inspection of the sheet on which the image is formed before the interruption of the job being executed is performed at the time of accepting the interruption job, the controller 200 interrupts the inspection after at least the read image inspection is completed. Specifically, upon receiving the interruption job, the controller 200 automatically sets the page to be interrupted in the predetermined job. Next, the controller 200 executes image formation and inspection of the predetermined job up to the set page to be interrupted, and then executes the interruption job.

In the present embodiment, the page to be interrupted in the predetermined job may be, for example, a page corresponding to an image to be formed on the sheet S fed last at the time point when the controller 200 has accepted the interruption job.

For example, it is assumed that the predetermined job is a job related to image formation and image inspection of 300 pages. Here, it is assumed that the interruption job occurs after the sheet of the one hundred sixty second (162^{nd}) page is fed. In this case, page 162 is set as the page to be interrupted, and a page related to the image formation of the interruption job is inserted between page 162 and page 163. Next, after the read image inspection of the sheet on which the image corresponding to page 162 is formed is completed, the interruption job is executed. After an interruption job is completed, the predetermined job is restarted from page 163.

As a result, the interruption job generated in the middle of the inspection can be quickly executed.

Furthermore, when the interruption job does not include inspection of a read image on a sheet, the controller 200 controls the inspecting device 50 not to inspect the sheet on which an image has been formed by the interruption job. That is, in a case where the interruption job does not include the inspection job, the controller 200 causes the sheet on which the image is formed by the interruption job to pass through the inspecting device 50 and to be discharged to the sheet ejection tray.

As a result, it is possible to suppress erroneous inspection in the interruption job that does not include the inspection job.

In addition, when the interruption job includes the inspection of the read image of the sheet, the controller 200 switches the reference image used in the inspection from the image related to the inspection of the predetermined job to the image related to the inspection of the interruption job. Then, after the interruption job is completed, the controller 200 switches the reference image used in the inspection from the image related to the inspection of the interruption job to the image related to the inspection of the predetermined job.

Accordingly, it is possible to suppress the use of the reference image of a different job in the inspection of the predetermined job or the inspection of the interruption job.

Furthermore, the controller 200 may change the sheet ejection tray between the predetermined job and the interruption job. For example, when there is a sheet ejection tray usable for the interruption job among the plurality of sheet ejection trays, the controller 200 ejects the sheet relating to the interruption job to a usable sheet ejection tray. The sheet ejection tray usable in the interruption job may be a tray to which no sheet is currently discharged, other than a tray to which a sheet in which no abnormality is detected is discharged and a tray to which a sheet in which an abnormality is detected is discharged in the predetermined job.

For example, in the configuration illustrated in FIG. 1, it is assumed that a tray onto which a sheet for which no abnormality has been detected in the predetermined job is ejected is the sheet ejection tray denoted by reference numeral 42, and a tray onto which a sheet for which an abnormality has been detected in the predetermined job is ejected is the sheet ejection tray denoted by reference numeral 43. In this case, the tray usable for the interruption job is the sheet ejection tray with the code 44.

In addition, the controller 200 performs a control so as to create both the report up to the interruption and the report after the restart as the inspection report of the predetermined job. Specifically, the controller 200 may control to combine the report until interruption and the report after restart to create the inspection report of the predetermined job.

As a result, since the examination report in which the report up to the interruption and the report after the restart are put together is created, the user can easily manage the examination report.

Note that the report up to the interruption and the report after the restart may be separately generated. As a result, the inspection results of the divided jobs can be separately confirmed. Further, during the execution of the job after the restart, the inspection report up to the interruption can be confirmed in advance.

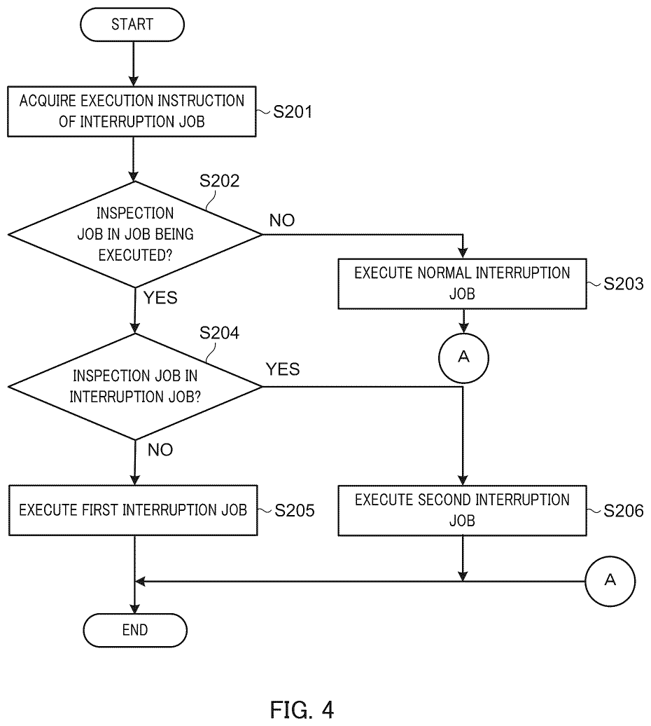

Next, a flow of an interruption job of the image inspection system 1 according to the present embodiment will be described. FIG. 4 is a flowchart illustrating an operation example of a case where the interruption job occurs in the image inspection system 1 according to the present embodiment. The process of FIG. 4 is executed, for example, when the controller 200 receives an instruction to execute the interruption job during execution of the process of FIG. 3 or during a print job that does not include image inspection.

As illustrated in FIG. 4, the controller 200 acquires the instruction to execute the interruption job (step S201), and determines whether the job being executed includes an inspection job (step S202). If it is determined that the inspection job is not included in the job being executed (NO in step S5202), the controller 200 performs normal interruption processing (step S203).

The normal interrupt process is a process of interrupting a job (print job) being executed, executing the interruption job, and then restarting the job being executed. This process may be, for example, a known process. In step S203, in a case where the normal interruption processing ends and the job in execution ends, the present control ends.

On the other hand, when the job under execution includes the inspection job (step S202, YES), the controller 200 determines whether or not the interruption job includes the inspection job (step S204).

As a result of the determination, when the interruption job does not include the inspection job (step S204, NO), the controller 200 executes first interruption processing (step S205). On the other hand, if the interrupting jobs include the inspecting job (step S204, YES), the controller 200 executes second interruption processing (step S206).

The first interruption processing is processing including the interruption job in a case where the inspection job is not included in the interruption job. The second interruption processing is processing including the interruption job in a case where the inspection job is included in the interruption job.

After step S205 or step 2, the present control ends.

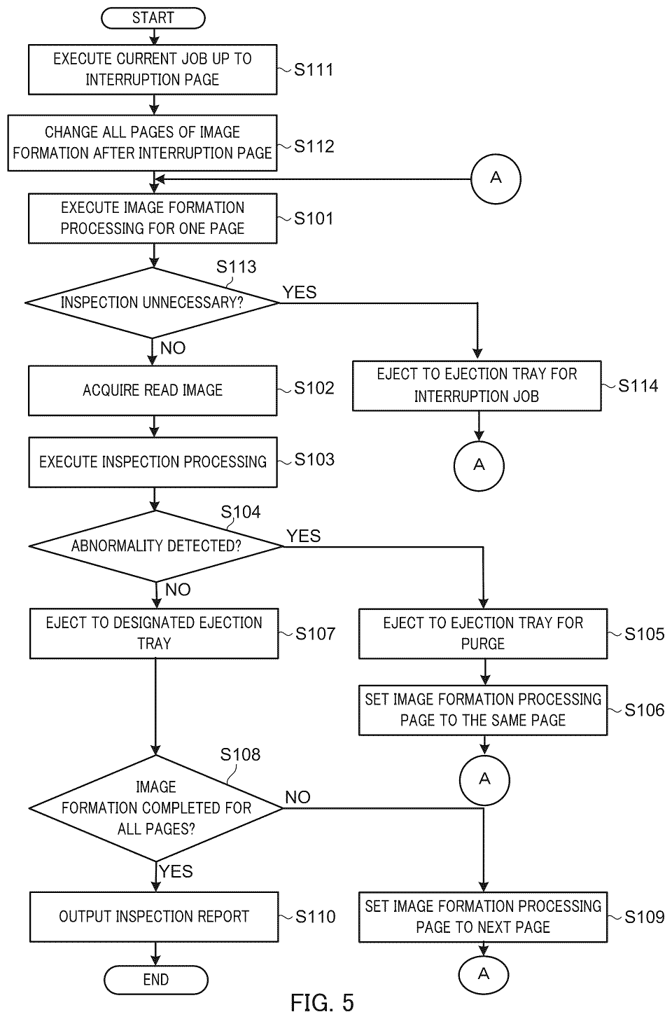

Next, a flow of the first interruption processing will be described. FIG. 5 is a flowchart illustrating an operation example of the first interruption processing. Note that the process of FIG. 5 is executed, for example, when the process of step S205 illustrated in FIG. 4 is executed. Furthermore, the processing of step S101 to step S110 in FIG. 5 is the same as the processing illustrated in FIG. 3.

As illustrated in FIG. 5, the controller 200 executes the job under execution up to the interrupted page (step S111). In step S111, the processing of step S105 up to the interrupted page or the processing up to the point in time when the processing of step S107 is completed in the processing of the flowchart of FIG. 3 is executed.

After step S111, the controller 200 changes all pages of the image formation after the interrupted page (step S112). Specifically, in the job of the image forming process, the controller 200 inserts all pages of the image forming process related to the interruption job after the interrupted page.

After step S112, the processing proceeds to step S101. Then, after step S101, the controller 200 determines whether or not the page on which the image forming process has been executed is a page that does not require inspection (step S113). That is, the controller 200 determines whether or not the page on which the image forming process has been executed is a page related to the interruption job.

As a result of the determination, in a case where the page on which the image forming process is executed is a page which does not needs to be inspected (step S113, YES), the controller 200 ejects the sheet on which the image is formed in step S101 to the sheet ejection tray for the interruption job (step S114). After step S114, the processing proceeds to step S101.

On the other hand, in a case where the page on which the image forming process is executed is not a page which does not needs to be inspected (step S113, NO), the process proceeds to step S102. Note that the processing illustrated in FIG. 4 may be executed in a case where the interruption job occurs after the image formation related to the interruption job is completed and the processing transitions to the processing of step S102 and thereafter.

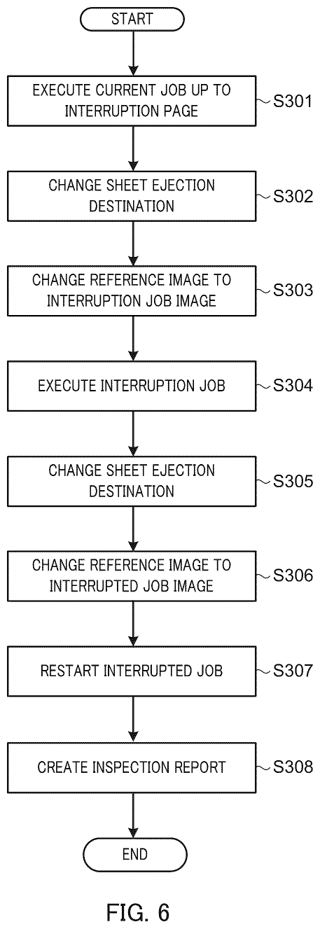

Next, a flow of the second interruption processing will be described. FIG. 6 is a flowchart illustrating an operation example of the second interruption processing. Note that the processing of FIG. 6 is executed, for example, when the processing of step S206 illustrated in FIG. 4 is executed.

As illustrated in FIG. 6, the controller 200 executes the job being executed up to the interrupted page (step S301). After step S301, the controller 200 changes the ejection destination of the sheet (step S302). In step S302, the controller 200 changes the ejection destination of the sheet to a sheet ejection tray different from the tray to which the sheet of the job being executed is ejected.

After Step S302, the controller 200 changes the reference image for the image inspection to the image of the interruption job (Step S303), and executes the interruption job (Step S304). The process of step S304 is the same as the process of the flowchart shown in FIG. 3.

In step S304, after the interruption job is completed, the controller 200 changes the discharge destination of the sheet (step S305). In step S305, the controller 200 changes the ejection destination of the sheet to the tray to which the sheet of the interrupted job has been ejected.

After Step S305, the controller 200 changes the reference image for image inspection to the image of the interrupted job (Step S306), and restarts the interrupted job (Step S307). The process of step S307 is the same as the process of the flowchart shown in FIG. 3. In step S307, when inspection of all the pages in the interrupted job is completed, the controller 200 outputs an inspection report (step S308). In this case, a combined inspection report of the inspection reports before and after interruption may be output.

After step S308, the present control ends.

According to the present embodiment configured as described above, when the interruption job is accepted during execution of the predetermined job, the controller 200 interrupts inspection and image formation of the job being executed. That is, in the present embodiment, when the interruption job occurs, the inspection and image formation of the job being executed are interrupted, and the interruption job is executed. As a result, the interruption job generated in the middle of the inspection can be quickly executed.

Furthermore, in the case where the read image inspection of the recording medium on which the image is formed before the interruption of the image formation of the job under execution is being performed at the time of accepting the interruption job, the image formation and the inspection of the job under execution are interrupted after at least the read image inspection is completed.

Accordingly, it is possible to suppress the predetermined job from being interrupted while the read image inspection is being performed. As a result, it is possible to quickly execute the predetermined job while reliably performing inspection of the job.

Furthermore, when the interruption job does not include the inspection of the read image, the controller 200 controls the inspecting device 50 not to inspect the sheet on which the image is formed in the interruption job. Thus, it is possible to suppress the inspection from being erroneously performed in the interruption job in which the inspection of the image is not required.

In addition, the controller 200 controls the image former 21 to form an image by inserting the page related to the image formation of the interruption job between pages before and after the interruption of the image formation of the predetermined job. Therefore, the image forming process of the interruption job can be executed as a series of image forming processes in combination with the image forming process of the predetermined job. As a result, since the interval between the interruption job and the predetermined job can be shortened, the processing time in the image inspection system 1 can be shortened as a whole.

When the interruption job includes the inspection of the read image of the sheet, the controller 200 switches the reference image used in the inspection from the image related to the inspection of the job to the image related to the inspection of the interruption job. As a result, it is possible to suppress the use of the reference image of a different job in the inspection of the predetermined job or the inspection of the interruption job.

In addition, since the controller 200 changes the tray to which the sheet is discharged between the predetermined job and the interruption job, it is possible to prevent the printed material of the predetermined job and the printed material of the interruption job from being mixed.

In the above-described embodiment, one of the first interruption processing and the second interruption processing is executed in accordance with whether or not the inspection job is included in the interruption job, but the present invention is not limited thereto. For example, the controller 200 may execute one of the first interruption processing and the second interruption processing in accordance with the number of pages in the interruption job.

As described above, the first interruption processing is a process of inserting the page of the image formation of the interruption processing into the data of the image formation of the job being executed and simply completing the interruption processing. Therefore, when the number of pages in the interruption job is larger than a predetermined value, the frequency of the process of distinguishing the pages related to the interruption job from the pages related to the job that has been originally executed (the process of step S113 in FIG. 5 and the like) increases, and there is a possibility that it takes time for the process.

Therefore, the controller 200 may execute the first interruption processing when the number of pages in the interruption job is equal to or smaller than a specified number, and may execute the second interruption processing when the number of pages is larger than the specified number. The specified number can be arbitrarily set, and may be set to, for example, a number that has little influence on image quality and production time (e.g., five pages or less). Furthermore, the specified number may be specifiable by the user.

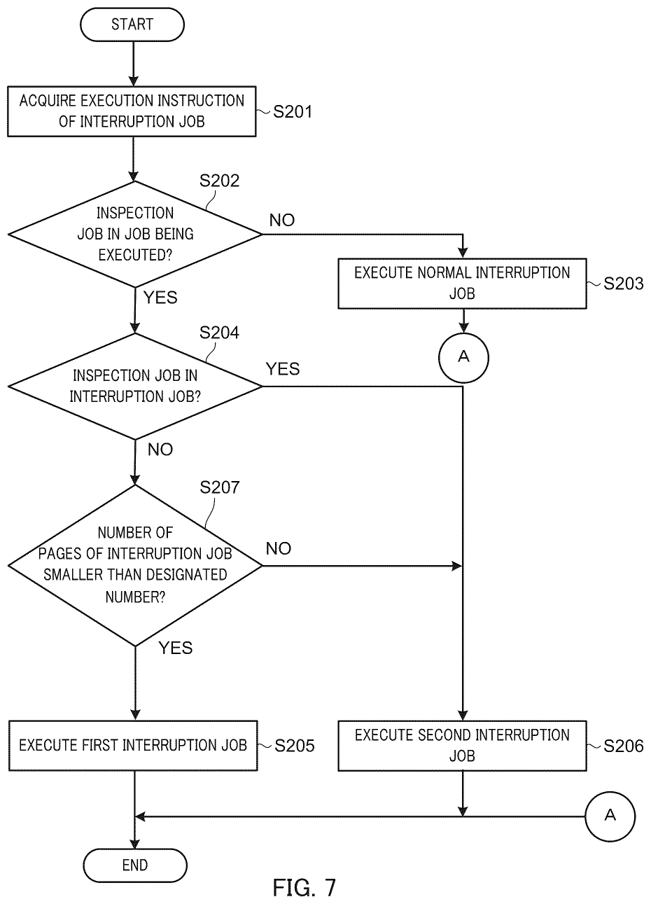

This process may be incorporated after NO is determined in step S204 of the flowchart shown in FIG. 4, for example, as in the process of step S207 shown in FIG. 7. Note that in the flowchart illustrated in FIG. 7, if the number of pages of the interruption job is equal to or smaller than the specified number (YES in step S207), the first interruption processing is executed (step S205). On the other hand, if the number of pages of the interruption job is larger than the specified number (NO in step S207), the second interrupt process is executed regardless of whether the interruption job is the inspection job (step S206).

Note that since the interruption jobs do not include the inspection job in the executed second interruption processing due to determination of NO in step S207, processing in step S303 and step S306 in FIG. 6 may not be executed.

By doing so, the first interrupt process can be simplified, and the interruption job can be completed quickly.

Furthermore, although the printed material of the predetermined job and the printed material of the interruption job are separately ejected to any of the plurality of sheet ejection trays in the above-described embodiment, the present invention is not limited thereto. For example, in a case where there is no sheet ejection tray usable for the interruption job, the printed material of the predetermined job and the printed material of the interruption job may be discharged to the same sheet ejection tray.

For example, in the first interruption processing, in the process of step S114 shown in FIG. 5, the sheet is discharged to the same sheet ejection tray as in the process of step S107. In addition, in the second interrupt process, the process of changing the discharge destination of the sheet in step S302 and step S305 shown in FIG. 6 is deleted.

Further, in this case, the controller 200 may execute a process of distinguishing the printed material by the predetermined job from the printed material by the interruption job.

The processing for distinguishing between jobs may be processing for inserting a delimiting sheet at a job breakpoint. The controller 200 inserts, for example, a separator sheet between the sheet corresponding to the page of the interruption place of the predetermined job and the sheet corresponding to the first page of the interruption job. Furthermore, the controller 200 inserts a separator sheet between the sheet corresponding to the last page of the interruption job and the sheet corresponding to the page at the restarting point of the predetermined job.

Furthermore, the processing for distinguishing may be processing of performing some kind of post-processing by the post-processing device 40, such as application of a delimiting tape, on a place of the job breakpoint. The controller 200 controls the post-processing device 40 to apply the delimiting tape to, for example, the sheet corresponding to the page of the interruption place of the predetermined job and the sheet corresponding to the page of the restart place of the predetermined job.

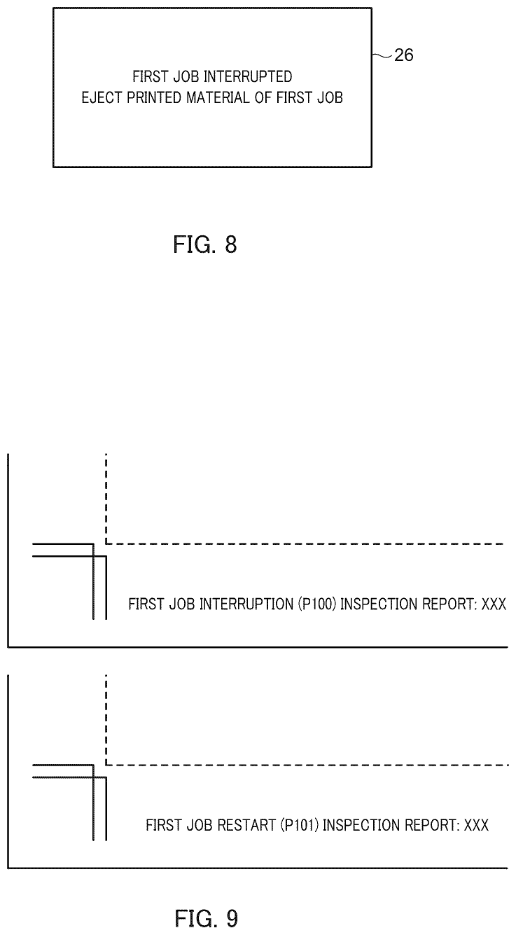

Furthermore, the processing for differentiating may be processing for notifying a user to take out a printed material from a sheet ejection tray at the time of a job breakpoint. For example, as illustrated in FIG. 8, the controller 200 controls the display 26 to display a display for instructing the user to take out the printed material. FIG. 8 illustrates an example in which the display 26 displays a message indicating that the first job has been interrupted and prompting the user to remove the printed material.

Furthermore, the processing for distinction may be processing for printing on a sheet corresponding to a place of a job breakpoint. For example, as illustrated in FIG. 9, the controller 200 controls the image former 21 so as to perform printing on a margin portion of each sheet of the interrupted page and the restarted page in the job. FIG. 9 illustrates an example in which printing indicating that the first job has been interrupted at the 100^{th} page of the first job and that the first job has been restarted at the one hundred first (101^{st}) page of the first job is provided in a margin portion of the sheet. Furthermore, printing may be performed on margin parts of the first and last pages of the interruption job, the first and last pages of the first job, and the like. Furthermore, in order to facilitate confirmation of the inspection report of the job, the number of the inspection report may be printed in a margin part of the sheet.

In this way, by performing processing for distinguishing between the printed material by the predetermined job and the printed material by the interruption job, even if printed materials of different jobs are discharged to the same sheet ejection tray, it is possible to distinguish which job the printed material is of. As a result, it is possible to suppress mixing of the printed material by the predetermined job and the printed material by the interruption job.

Furthermore, when the printed material of the predetermined job and the printed material of the interruption job are ejected to the same sheet ejection tray, for example, in the first interruption processing, in the processing of step S114 illustrated in FIG. 5, a sheet may be ejected to the same sheet ejection tray as in the processing of step S107. Furthermore, in a case where the printed material of the predetermined job and the printed material of the interruption job are ejected to the same sheet ejection tray, the first interruption processing may not be executed.

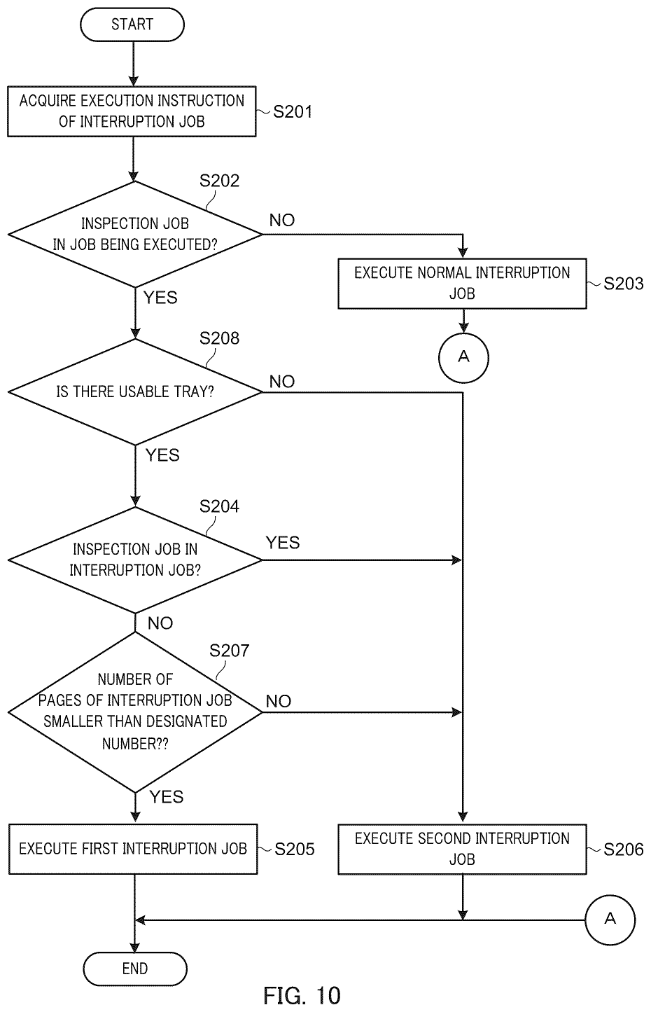

This processing is executed by, for example, the flowchart illustrated in FIG. 10. The flowchart illustrated in FIG. 10 is obtained by adding the processing of step S208 after it is determined as YES in step S202 of the flowchart illustrated in FIG. 7.

In step S208, the controller 200 determines whether or not there is the usable sheet ejection tray. If the determination result is that there is the usable sheet ejection tray (step S208, YES), the process transitions to step S204. On the other hand, when there is no usable sheet ejection tray (step S208, NO), the process proceeds to step S206.

Further, in a case where the printed material of the predetermined job and the printed material of the interruption job are discharged to the same sheet ejection tray, the process of changing the discharge destination of the sheet in step S302 and step S305 shown in FIG. 6 may be deleted in the second interruption processing. Furthermore, in the second interruption processing, whether the printed material of the predetermined job and the printed material of the interruption job are to be ejected to the same sheet ejection tray or to different sheet ejection trays may be selected. In this case, any of a plurality of different processes may be executed based on the selection result.

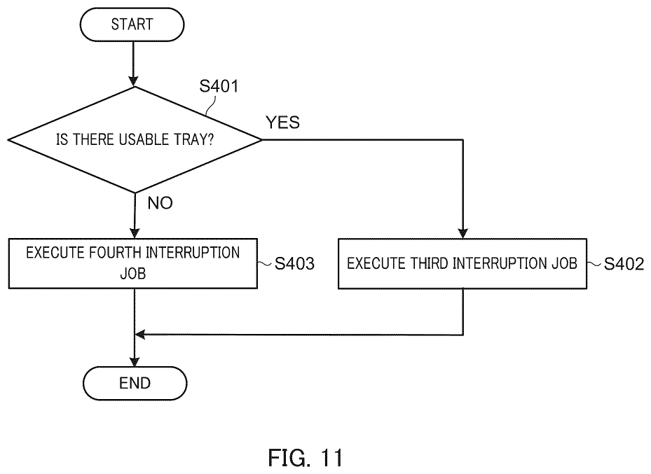

For example, in the flowchart illustrated in FIG. 11, when the second interrupt process is executed, the controller 200 determines whether or not there is the usable sheet ejection tray (step S401). As a result of the determination, when there is the usable sheet ejection tray (step S401, YES), the controller 200 executes third interruption processing (step S402). On the other hand, when there is no usable sheet ejection tray (step S401, NO), the controller 200 executes fourth interruption processing (step S403). After step S402 or step S403, the present control ends.

The third interrupt process is, for example, a process similar to the flowchart illustrated in FIG. 6.

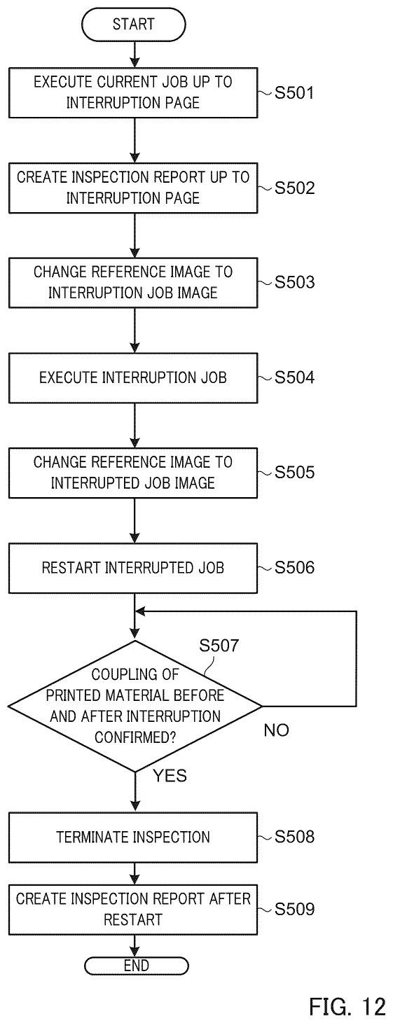

The fourth interruption processing is a process including an operation of checking whether the printed materials before and after the interruption are appropriately combined because the printed materials of different jobs are discharged to the same sheet ejection tray. The fourth interrupt process may be, for example, a flowchart as illustrated in FIG. 12.

As illustrated in FIG. 12, the controller 200 executes the job under execution up to the interrupted page (step S501). After step S501, the controller 200 creates an inspection report up to the interrupted page (step S502). Between step S501 and step S502, for example, as illustrated in FIG. 8, an instruction for prompting the user to take out the printed material of the job in execution may be displayed.

Thus, after the user interrupts the job, the printed material up to the interrupted page can be taken out from the sheet ejection tray and retracted.

After Step S502, the controller 200 changes the reference image for the image inspection to the image of the interruption job (Step S503), and executes the interruption job (Step S504). The processing of step S504 is the same as the processing of the flowchart illustrated in FIG. 3 and the like.

In step S504, after the interruption job is completed, the controller 200 changes the reference image for image inspection to the image of the interrupted job (step S505), and restarts the interrupted job (step S506). The process of step S506 is the same as the process of the flowchart shown in FIG. 3. Furthermore, before the processing in step S506 is started, the controller 200 may perform processing for notifying the user to take out the printed material of the interrupting job from the sheet ejection tray.

After step S506, the controller 200 determines whether the combination of the printed materials before and after the interruption is confirmed (step S507). The confirmation of the combination of the printed materials before and after the interruption is performed by, for example, the user.

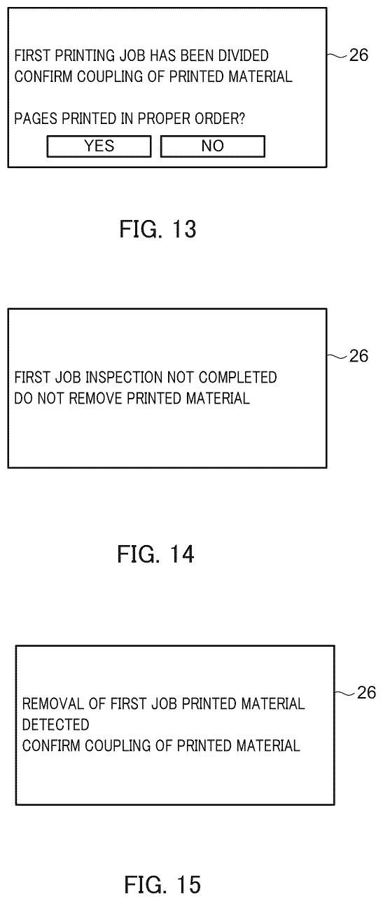

For example, the controller 200 outputs a confirmation command for causing the user to confirm the combination of the interrupted page and the restarted page in the printed material of the job. Specifically, As illustrated in FIG. 13, an instruction to prompt the user to combine the printed materials before and after the interruption in the job is displayed on the display 26. FIG. 13 illustrates an example in which displays indicating that the first job has been divided and printed, prompting the user to confirm the combining of the printed materials, and asking the user whether the printed materials have been combined are provided on the display 26.

Based on this display, the user combines the printed materials before and after the interruption, and checks that the printed materials are appropriately combined. After the confirmation, the user presses a confirmation button of the input device 27. Thus, the controller 200 determines that the combination of the printed materials before and after the interruption has been confirmed.

As a result of the determination, when the combining of the printed materials before and after the interruption is not confirmed (NO in step S507), the process in step S507 is repeated. On the other hand, when the combination of the printed materials before and after the interruption is confirmed (step S507, YES), the controller 200 ends the inspection (step S508). In other words, the controller 200 terminates the inspection in the inspecting device 50 based on the information of the confirmation result by the user in the confirmation command.

Then, the controller 200 outputs the inspection report of the restarted job (step S509). After step S509, the present control ends. Note that if it is confirmed in the user confirmation that the printed materials before and after the interruption cannot be appropriately combined, the controller 200 may be able to acquire, from the user via the input device 27, information indicating that the printed materials before and after the interruption cannot be appropriately combined. When this information is acquired, the controller 200 may record the fact that the inspection cannot be performed in the inspection report.

In this way, it is possible to confirm whether the printed materials before and after the interruption are appropriately combined, and therefore, even if the job is interrupted by the interruption job, the predetermined job can be appropriately completed.

In addition, in the third interruption processing, since the printed material by the predetermined job and the printed material by the interruption job are discharged to different ejection trays, the controller 200 may execute processing for prohibiting the printed material of the interrupted job from being taken out from the ejection tray.

In a case where the sheet ejection tray can be pulled out from the inside of the post-processing device 40, the process of prohibiting the printed material from being taken out from the sheet ejection tray may be a process of locking the pulling-out of the sheet ejection tray.

Furthermore, the processing for prohibiting removal of the printed material from the sheet ejection tray may be processing for notifying a user not to remove the printed material from the sheet ejection tray. For example, as illustrated in FIG. 14, the controller 200 controls the display 26 to provide a display for instructing the user not to take out the printed material. FIG. 14 illustrates an example in which a display indicating that the inspection of the first job is not completed and prompting not to take out the printed material is displayed on the display 26.

Furthermore, in a case where the user removes the printed material even when the processing for prohibiting removal of the printed material from the sheet ejection tray is executed, the controller 200 may switch the process from the third interruption processing to the fourth interruption processing.

In the fourth interruption processing, as described above, an operation of confirming whether the printed materials before and after the interruption are combined is performed. Therefore, when removal of the printed material is detected, the controller 200 controls the display 26 to provide a display prompting the user to check the printed material, as illustrated in FIG. 15. FIG. 15 illustrates an example in which a display indicating that removal of the printed materials of the first job has been detected and that combining of the printed materials is to be confirmed is provided on the display 26.

Furthermore, in the example illustrated in FIG. 11, the third interruption processing or the fourth interruption processing is executed according to the presence or absence of the usable sheet ejection tray, but the third interruption processing or the fourth interruption processing may be executed according to the execution time of the interruption job.

For example, in a case where the number of pages of the interruption job is larger than the predetermined value (in a case where the execution time is long), it is more important to confirm whether the printed material before the interruption and the printed material after the restart are appropriately combined, for example, the printed material of the interruption job is likely to be mixed in. On the other hand, in a case where the number of pages of the interruption job is smaller larger than a predetermined value (in a case where the execution time is short), it is possible to immediately take out the printed material of the interruption job, and therefore, some users may not need the above-described confirmation. Further, in the third interruption processing, the sheet ejection tray is divided between the printed material of the job before interruption and the printed material of the interruption job. Furthermore, in a case where the execution time of the interruption job is considerably short (i.e., shorter than a predetermined time period), there is no time for the user to perform work (physical work) for taking out the printed material before the interruption. While there is no time for the user to take out the printed material, the printed material before the interruption and the printed material after the restart are ejected to the same sheet ejection tray in an overlapping manner, with the result that the user does not needs to perform confirmation thereof. Furthermore, even if the user has time to take out the printed material before interruption, the user does not have to take out the printed material in the first place without time (e.g., about 10 minutes) to confirm whether the printed material is appropriate. For these reasons as well, the user might not make the above confirmation if the number of pages in the interruption job is smaller larger than the predetermined value.

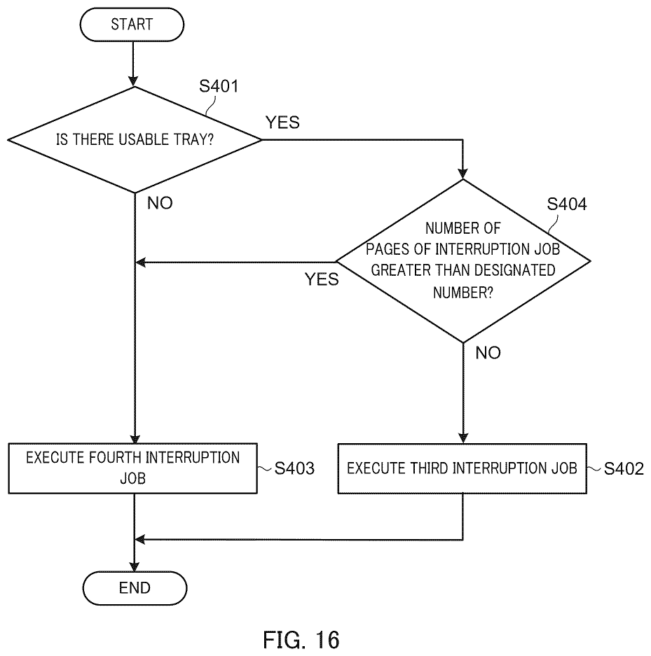

Therefore, as illustrated in FIG. 16, after determining YES in step S401 of FIG. 11, the controller 200 determines whether the number of pages of the interruption job is equal to or more than the predetermined number (step S404). The predetermined number is a number that can be arbitrarily set, and is a value obtained by multiplying the printing speed of the device by the execution time. For example, when an execution time of about 10 minutes is used as a reference, the predetermined number is 500 pages if the printing speed of the device is 50 page per minute (PPM).

As a result of the determination, when the number of pages of the interruption job is smaller than the predetermined number (step S404, NO), the process proceeds to step S402. On the other hand, when the number of pages of the interruption job is equal to or more than the predetermined number (YES in step S404), the process proceeds to step S403.

Furthermore, the third interruption processing or the fourth interruption processing may be executed according to whether or not the setting of the user confirmation is present. In the user confirmation, for example, whether or not the confirmation is performed by the fourth interruption processing may be set in advance by the user.

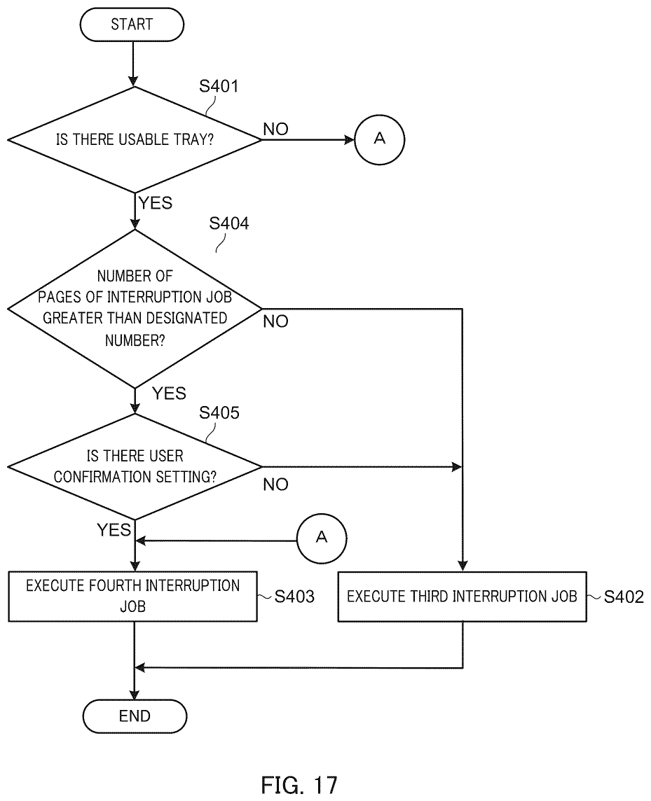

For example, as illustrated in FIG. 17, after determining YES in step S404 of FIG. 16, the controller 200 determines whether or not there is the setting for user confirmation (step S405). If the determination result is that there is no setting for user confirmation (step S405, NO), the process transitions to step S402. On the other hand, when there is the setting for user confirmation (step S405, YES), the process transitions to step S403.

Furthermore, although the page to be interrupted in the predetermined job is the page corresponding to the image to be formed on the sheet fed last at the time point when the controller 200 receives the interruption job in the embodiment described above, the present invention is not limited to this. For example, the controller 200 may set a page to be interrupted according to a difference between a separator page serving as a job breakpoint and a printed page.

For example, when the job includes a plurality of sections/copies, the separator page may be the last page of any of the sections/copies. Furthermore, the separator page may be, for example, an end page with a consecutive number in variable printing.

For example, assume that during execution of the predetermined job, the printed page at the time when the controller 200 receives the interruption job is the 50th page. For example, assume that the first separator page after the 50th page in the job is the 53rd page. In this case, since the difference between the separator page and the printed page is smaller than a predetermined value (e.g., five, ten, or the like), for example, the controller 200 sets the separator page as the page to be interrupted.

Furthermore, assume that the first separator page after the 50th page in the job is the 100th page. In this case, since the difference between the separator page and the printed page is larger than the predetermined value, the start of the interruption job is delayed. Therefore, the controller 200 does not set the separator page as the page to be interrupted, but sets, for example, the 55th page as the page to be interrupted.

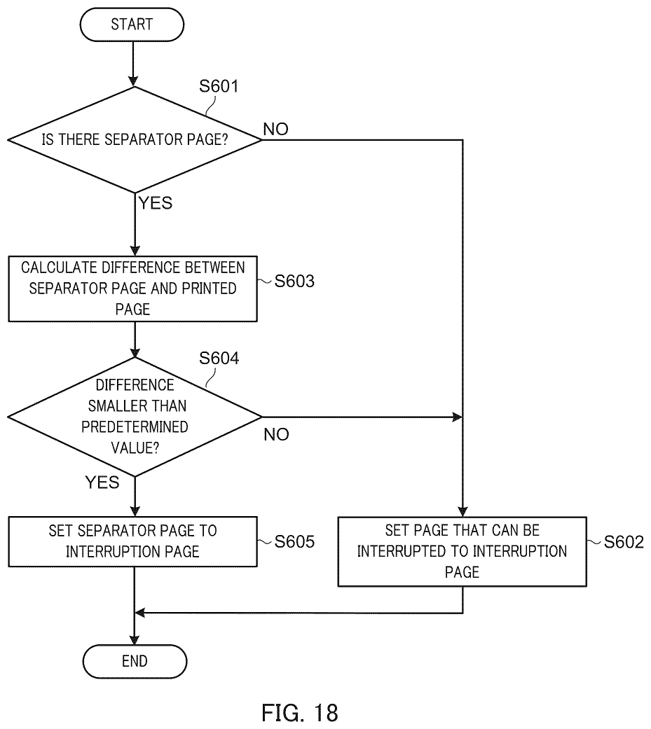

The setting control of the page to be interrupted is executed by, for example, a flowchart shown in FIG. 18. The flowchart illustrated in FIG. 18 is executed as appropriate, for example, at the time point when the controller 200 receives the interruption job during execution of the predetermined job.

As illustrated in FIG. 18, the controller 200 determines whether there is a separator page (step S601). As a result of the determination, if there is no separator page (NO in step S601), the controller 200 sets a page that can be interrupted as an interrupted page (step S602). The interruptible page may be an arbitrary page, for example, a page corresponding to a sheet fed last from the sheet feeder.

On the other hand, if there is the separator page (YES in step S601), the controller 200 calculates the difference between the separator page and the printed page (step S603).

After step S603, the controller 200 determines whether or not the difference between the separator page and the printed page is equal to or smaller than a predetermined value (step S604). The predetermined value is a number that can be arbitrarily set, for example, the number of pages such that the execution time of the job from the printed page to the separator page is a relatively short time (i.e., a time period shorter than a predetermined time period).

As a result of the determination, when the difference between the separator page and the printed page is larger than the predetermined value (step S604, NO), the process proceeds to step S602. On the other hand, when the difference between the separator page and the printed page is equal to or smaller than the predetermined value (step S604, YES), the controller 200 sets the separator page as the interruption page (step S605). After step S602 or step S605, the present control ends.

Note that after determining YES in step S604, the controller 200 may determine whether or not the predetermined value is equal to or larger than the interruptible number of pages. The interruptible number of pages is, for example, the number of sheets fed into the image forming device 20 when the interruption job occurs. When the predetermined value is smaller than the interruptible number of pages, there is a possibility that the sheet remains in the image forming device 20 without being printed due to interruption of the job. Therefore, when the predetermined value is equal to or more than the number of interruptible pages, the controller 200 can set the separator page as the interrupted page. Further, when the predetermined value is smaller than the number of interruptible pages, the controller 200 may set, for example, the separator page as the next separator page, and the process may return to step S603 again.

Furthermore, the page to be interrupted in the predetermined job may be settable by the user. For example, at the start of the predetermined job (inspection job), the user may make settings related to the page to be interrupted via a setting screen of the inspecting device 50 displayed on the display 26.

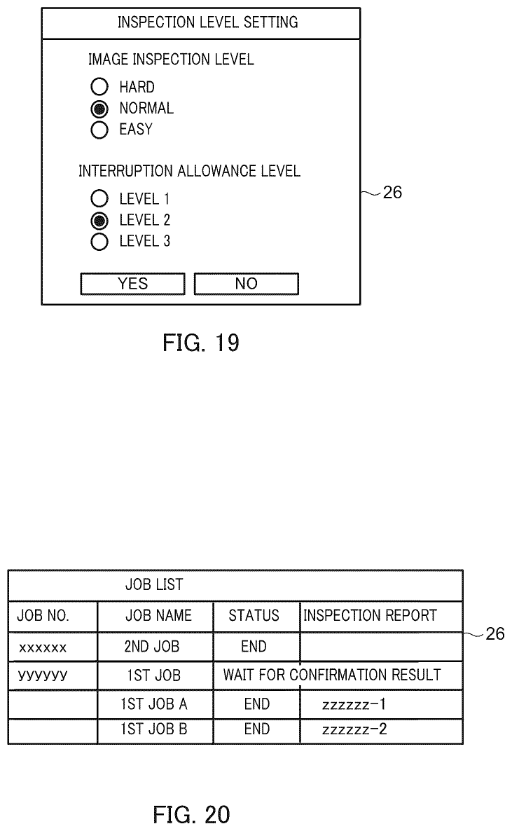

For example, FIG. 19 illustrates an example of the setting screen of the display 26. On the setting screen, a page to be interrupted can be set in a portion of “interruption, interruption permission level”. For example, level 1 is a setting in which a job cannot be interrupted. Level 2 is a setting in which interruption at a separator page is possible. Level 3 is a setting in which interruption corresponding to a page at the time of reception of the interruption job is possible.

When the interruption job is entered, the predetermined job is divided into two. Therefore, for example, each of the two divided jobs may be displayed in the job list displayed on the display 26. That is, the controller 200 may perform control such that the job list on the display 26 is displayed separately until interruption of the job and after restart of the job.

FIG. 20 shows an example in which a first job A indicating a job before interruption and a first job B indicating a job after restart are displayed in the job list. In FIG. 20, the second job corresponding to the interruption job is also displayed at the same time.

FIG. 20 also illustrates that creation of the inspection report is also completed for each job, but the merge confirmation of two jobs is waited.

Further, in the above-described embodiment, the controller 200 receives the interruption job, but the present invention is not limited thereto, and another receiver may receive the interruption job, and the controller 200 may acquire information indicating that the receiver has received the interruption job.

Furthermore, although the interruption job is started after the end of the read image inspection in a case where the read image inspection of the sheet on which the image is formed before the interruption of the job in execution is performed when the interruption job is received in the above-described embodiment, the present invention is not limited thereto. For example, in a case where the interruption job does not include the inspection job and there is a conveyance path that bypasses or avoids the inspecting device, the interruption job may be started before the read image inspection is completed.

In addition, each of the above-described embodiments is merely an example for embodying the present invention, and the technical scope of the present invention should not be interpreted in a limited manner by these embodiments. That is, the present invention can be implemented in various forms without departing from the spirit or main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection system comprising:
an image former that forms an image on a recording medium based on a job; and
a hardware processor that acquires a read image obtained by reading the image formed on the recording medium, wherein
the hardware processor:
inspects the read image,
receives an interruption job, and
interrupts inspection and image formation of the job being executed when the interruption job is received during execution of the job.

2. The image inspection system according to claim 1, wherein in a case where a read image inspection of the recording medium on which the image is formed before interruption of the image formation of the job being executed is being performed when the hardware processor receives the interruption job, the hardware processor interrupts the inspection and the image formation of the job at least after the read image inspection is completed.

3. The image inspection system according to claim 1, wherein in a case where the interruption job does not include a read image inspection of the recording medium, the hardware processor performs a control so as not to inspect the recording medium on which the image is formed in the interruption job.

4. The image inspection system according to claim 1, wherein the hardware processor controls the image former so as to form an image by inserting a page for the image formation of the interruption job between pages before and after interruption of the image formation of the job.

5. The image inspection system according to claim 1, wherein
the hardware processor:
sets a page for which the image formation of the job is interrupted, and
executes the interruption job after executing the inspection and the image formation of the job up to the page for which the image formation of the job is interrupted.

6. The image inspection system according to claim 1, wherein in a case where the interruption job includes a read image inspection of the recording medium, the hardware processor switches a reference image used for the inspection from an image related to the inspection of the job to an image related to an inspection of the interruption job.

7. The image inspection system according to claim 1, wherein the hardware processor performs a control so as to display a job up to interruption of the image formation of the job and a job after restart separately in a job list on a display.

8. The image inspection system according to claim 1, wherein the hardware processor performs a control so as to create a report up to interruption of the image formation of the job and a report after restart of the job.

9. The image inspection system according to claim 8, wherein the hardware processor performs a control so as to create the report up to the interruption and the report after the restart together.

10. The image inspection system according to claim 1, further comprising:
a sheet ejector including a plurality of trays, wherein
the hardware processor switches a tray for ejection between the job and the interruption job.

11. The image inspection system according to claim 1, further comprising:
a sheet ejector, wherein
the hardware processor executes a process of prohibiting a printed material of the job being interrupted from being taken out from the sheet ejector.

12. The image inspection system according to claim 1, wherein the hardware processor executes a process of distinguishing between a printed material of the job and a printed material of the interruption job.

13. The image inspection system according to claim 1, wherein the hardware processor controls the image former so as to perform printing on an interrupted page and a restarted page of the job in a margin of each recording media.

14. The image inspection system according to claim 1, wherein the hardware processor automatically sets a page to be interrupted in the job.

15. The image inspection system according to claim 14, wherein the hardware processor sets the page to be interrupted in accordance with a difference between a separator page serving as a separator in the job and a printed page.

16. The image inspection system according to claim 14, wherein
the hardware processor sets:
an inspection level for each inspection job, and
the page to be interrupted in accordance with the inspection level.

17. The image inspection system according to claim 1, wherein the hardware processor outputs a confirmation command for causing a user to confirm an interrupted page and a restarted page in a printed material of the job.

18. The image inspection system according to claim 17, wherein the hardware processor terminates the inspection based on information on a user's confirmation result in the confirmation command.

19. An inspection device comprising:
a hardware processor that acquires a read image obtained by reading an image formed on a recording medium based on a job, wherein
the hardware processor:
inspects the read image,
receives an interruption job, and
interrupts inspection and image formation of the job being executed when the interruption job is received during execution of the job.

20. An inspection method for an image in an image inspection system, the method comprising:
forming an image on a recording medium based on a job; and
acquiring a read image obtained by reading the image formed on the recording medium,
inspecting the read image,
receiving an interruption job, and
interrupting inspection and image formation of the job being executed when the interruption job is received during execution of the job.

21. A computer-readable recording medium storing an inspection program of an image in an image inspection system, the inspection program causes a computer to execute:
a process of forming an image on a recording medium based on a job; and
a process of acquiring a read image obtained by reading the image formed on the recording medium,
a process of inspecting the read image,
a process of receiving an interruption job, and
a process of interrupting inspection and image formation of the job being executed when the interruption job is received during execution of the job.
